(19) United States
(12) Patent Application Publication
(10) Pub. No.: US 2009/0173838 A1
(43) Pub. Date: Jul. 9, 2009

(54) Narrow Wing System for Airplanes

(76) Inventors: WALTER GRILL, MUNICH (DE); SEBASTIAN SCHNEEWEISS, CAMBRIDGE, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/464,679

(22) Filed: Aug. 15, 2006

(51) Int. Cl. B64C 3/10; B64C 5/00; B64C 9/00; B64C 13/00; B64C 23/00; B64C 25/10

(52) U.S. Cl. 244/35 R; 244/198; 244/90 R; 244/90 A; 244/130; 244/102 R; 244/87

(57) ABSTRACT

An extra narrow wing system for airplanes combining the advantages of sufficient lift like a conventional airplane wing with reduced space requirements. A V-shaped nudge at the back side of the main wing helps to overcome the limitations of extreme delta-wings and allows very narrow wings with angles of as low as 0 degrees but sufficient lift for a propeller or jet operated plane. Front and tail wings are one aerodynamic system. The system results in very narrow airplane designs useful when operating under space constraints.

### CROSS-REFERENCE TO RELATED APPLICATIONS

None.

### BACKGROUND OF THE INVENTION

1. Field of the Invention

The present invention relates to single-body aircraft with very narrow wing span.

2. Description of the Prior Art

Patent Literature

Publications

### PROBLEM SOLVED BY THE PRESENT INVENTION

Future airplanes, particularly for use on aircraft carriers or in crowded ground conditions, should satisfy the following requirements:

1. Have narrow wingspan to allow take off and landing on narrow spaces, i.e. aircraft carrier, roads.

2. Maximize cruise lift despite narrow wingspan, to provide sufficient lift and allow low take off and landing speeds.

3. Have wingspans that allow economic storage and parking without requiring folding wings.

4. Provide a low to modest level of technical risk and certification risk.

### BRIEF SUMMARY OF THE INVENTION

An extra narrow wing system for airplanes combining the advantages of sufficient lift like a conventional airplane wing with reduced space requirements. A V-shaped nudge at the back side of the main wing helps to overcome the limitations of extreme delta-wings and allows very narrow wings with angles of as low as 0 degrees but sufficient lift for a propeller or jet operated plane. Front and tail wings are one aerodynamic system. The system results in very narrow airplane designs useful when operating under space constraints.

### BRIEF DESCRIPTION OF THE SEVERAL VIEWS OF THE DRAWING

FIG. 1 is a top view of an extra narrow wing system for airplanes according to the present invention (1:100);

FIG. 2 is a plan view of an extra narrow wing system for airplanes according to the present invention (1:100);

FIG. 3 is a front view of an extra narrow wing system for airplanes according to the present invention (1:100);

### DETAILED DESCRIPTION OF THE INVENTION

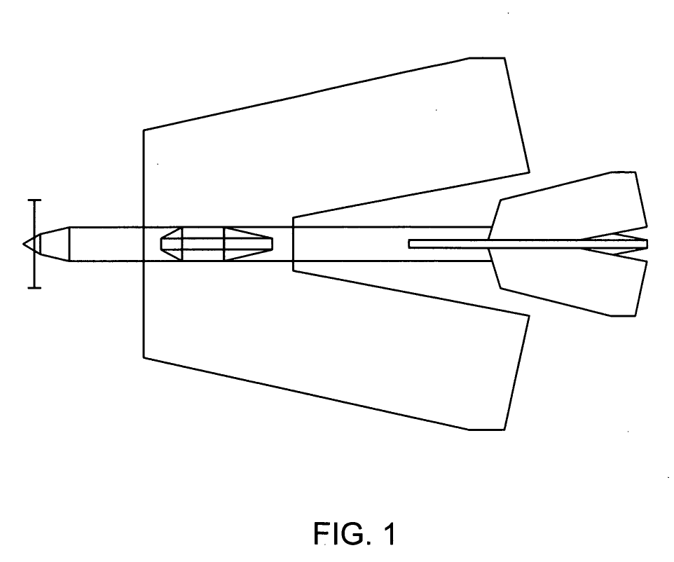

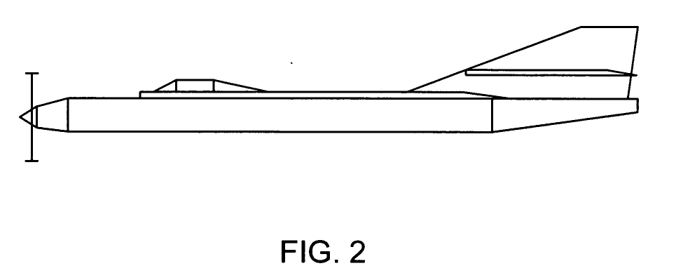

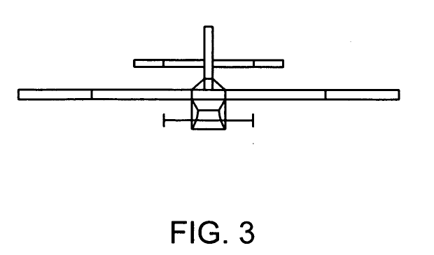

FIG. 1 is a front view, FIG. 2 a plan view, and FIG. 3 is a front view of a preferred embodiment of the invention. FIGS. 1, 2, and 3 illustrate the specific shape of the extra narrow wing.

The wing shape can be used either with propeller or jet engines.

The wings shown in FIGS. 1, 2 and 3 may have different profiles although the specific implementation shown is using a flat surface.

The wings shown in FIGS. 1, 2 and 3 may utilize fabrication materials such as metal, composite, or other materials or combinations of materials. Benefits may be achieved through utilization of stitched RFI composite structure.

The main wing and the tail wing are one wing system that allows for stable flying when used together.

The specific airplane configuration of FIGS. 1 through 3 provides low drag per seat.

While certain preferred embodiments of the invention have been described with reference to the attached figurers, it should be understood that further variations and modifications are possible within the spirit and scope of the invention.

1. An airplane configuration comprising: a fuselage; a main wing that extends from the fuselage and stretches along the fuselage; the main wine having a V-shaped nudge at a backside; and a tail wing adapted to the main wing.

2. (canceled)

3. The airplane configuration of claim 1, wherein the main wing is swept back.

4. The airplane configuration of claim 1, wherein the main wing is swept forward.

5. The airplane configuration of claim 1, further comprising trailing edge flaps for enhancing lift.

6. The airplane configuration of claim 1, further comprising leading edge high lift devices comprising slats, Kruegers, or flaps on the main wing for enhancing lift.

7. The airplane configuration of claim 1, further comprising ailerons on the main wing for contributing to airplane roll control.

8. The airplane configuration of claim 1, further comprising spoilers on the main wing for contributing to airplane roll control.

9. The airplane configuration of claim 1, further comprising wing tip devices comprising winglets on the outer tips of the main wing for reducing airplane induced drag.

10. The airplane configuration of claim 1, further comprising at least two engines which serve as means for providing thrust.

11. The airplane configuration of claim 1, further comprising landing gear including wheels and tires, for enabling the airplane to take off and land on narrow runway surfaces.

12. The airplane configuration of claim 14, further comprising means for retracting some main gear wheels and tires of the landing gear into an unpressurized aft portion of the main wing.

13. The airplane configuration of claim 1, further comprising empennage means for contributing to the stability and control of the airplane.

14. The airplane configuration of claim 13, wherein the empennage means includes at least one stabilizer surface structurally connected to a left sidebody, and at least one stabilizer surface structurally connected to a right sidebody.

15. The airplane configuration of claim 13, wherein the empennage means includes a low tail.

16. The airplane configuration of claim 13, wherein the empennage means includes a tail element connecting the left sidebody and the right sidebody.

17. The airplane configuration of claim 13, wherein the empennage means includes elevator means for airplane pitch control.

18. The airplane configuration of claim 13 wherein the empennage means includes rudder means for yaw control.
